(19) United States
(12) Patent Application Publication
(10) Pub. No.: US 2003/0115090 A1
(43) Pub. Date: Jun. 19, 2003

(54) Method to define an optimal integrated action plan for procurement, manufacturing, and marketing

(76) Inventors: Shahid Mujtaba, Milpitas, CA (US); Cipriano A. Santos, Riverbank, CA (US); Dirk M. Beyer, Mountain View, CA (US); Alex Xin Zhang, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/023,960

(22) Filed: Dec. 17, 2001

(51) Int. Cl. G06F 17/60

(52) U.S. Cl. 705/8

(57) ABSTRACT

A method to define an optimal integrated action plan for procurement, manufacturing, and marketing is disclosed. In one method embodiment, the present invention accesses materials planning parameters. The present invention further accesses pricing parameters. The present invention then evaluates the materials planning parameters and the pricing parameters in conjunction to define an optimal integrated action plan for marketing and manufacturing. This plan describes procurement amounts, manufacturing amounts, and pricing for end products.

### TECHNICAL FIELD

The present claimed invention relates to the field of inventory control. More particularly, the present claimed invention relates to an optimal integrated action plan for procurement, manufacturing, and marketing

### BACKGROUND ART

In the business organization there are branches of manufacturing and branches of marketing. Each branch works within a company with a common goal. This goal is to generate profit. In order to facilitate the generation of profit, the specific desires of the marketing branch and manufacturing branch are not common. The marketing branch aspires to sell more product than expected, thus desiring a surplus of product. However, the manufacturing branch strives to build only the amount of product that can be sold, thus not desiring a surplus of products or parts. Therefore, at the end of a production life cycle, when a product is being discontinued, the discrepancy in motivation between marketing and manufacturing grows larger.

In a perfect world, the marketing branch would sell all remaining products in a discontinued line. Further, the manufacturing branch would build just enough products to ensure that, at the time of discontinuance, no excess products or parts remained. In the real world, many constraints are placed upon both branches. These constraints cause a discontinuity in product inventory affecting both production and sales.

Specifically, once a product is going to be discontinued, a company will normally take a few precautionary steps in order to mitigate the risk. One of the primary steps is the layout of a discontinuation budget. With this budget, the manufacturing branch is then constrained in the amount of money it can spend on part supplies. This limit applied to the part supplies rolls over into a limit on the final amount of product that can be manufactured. Further, a timeline is normally established by the company with regard to when the manufacturing branch will cease making the specific product. This timeline effectively limits the building capability of the manufacturing branch. Specifically, due to the time constraint, only a specific number of products can be built in the allotted discontinuance time.

The amount of products that may be manufactured before a discontinuance is not only limiting to the manufacturing branch, it also directly effects the marketing branch. A simple marketing rule is that the amount of product you can sell depends on the price that you charge. Further, the price that is charged directly drives company profit. Therefore, pricing is an integral part of the discontinuation process. Currently, the manufacturing branch asks the marketing branch how many products in a discontinuing line they can sell. The marketing branch evaluates the consumer market and arrives at a production number. This production number is then taken as the goal of the manufacturing branch and drives most of the discontinuation decisions.

One disadvantage with this system is that the final production number, which the marketing branch supplies to the manufacturing branch, is evaluated at a specific price. Therefore, if the manufacturing branch cannot build the allotted amount of product, due to time constraints, production capacity limits, or parts limitations, the predicted profit which is also made by the marketing branch will not be realized. Further, this production number can result in a large number of surplus parts that must be scrapped at the time of discontinuation. Additionally, the scrapping of surplus parts further reduces the predicted profit margin.

A further disadvantage is the separation between the marketing branch and the manufacturing branch. If the previously mentioned inability to produce the desired number of products is recognized by the manufacturing branch, the manufacturing branch needs to inform the marketing branch of the shortfall. This feedback between manufacturing and marketing is slow and most of the decisions which are made are based solely on subjective judgment, prior experience and tradition.

In summary, the separate entities responsible for procurement, manufacturing, and marketing coordination are hierarchical: forecasts are passed from marketing to manufacturing, material requirements are passed from manufacturing to procurement, and finished goods inventory-figures are passed from manufacturing to marketing. All decisions are then made locally taking the others functions' static input. In so doing, locally optimal decisions, in general, do not produce a globally optimal outcome.

Therefore, there exists a need in the prior art for a method to define an optimal integrated action plan for procurement, manufacturing, and marketing. A further need exists for a method to define an optimal integrated action plan for procurement, manufacturing, and marketing which enables a price per product dependent on the amount of product which can be manufactured. Yet another need exists for a method to define an optimal integrated action plan for procurement, manufacturing, and marketing which meets the above needs and which allows the manufacturing decisions to implicitly make the pricing decisions. A further need exists for a method to define an optimal integrated action plan for procurement, manufacturing, and marketing which meets the above needs and which is based on objective data and facts.

### DISCLOSURE OF THE INVENTION

The present invention provides, in various embodiments, a method to define an optimal integrated action plan for procurement, manufacturing, and marketing. It further provides a method to define an optimal integrated action plan for procurement, manufacturing, and marketing which enables a price per product dependent on the amount of product which can be manufactured. The present invention also a method to define an optimal integrated action plan for procurement, manufacturing, and marketing which meets the above needs and which allows the manufacturing decisions to implicitly make the pricing decisions. The present invention further provides a method to define an optimal integrated action plan for procurement, manufacturing, and marketing which meets the above needs and which is based on objective data and facts.

Specifically, in one method embodiment, the present invention accesses materials planning parameters. The present invention further accesses pricing parameters. The present invention then evaluates the materials planning parameters and the pricing parameters in conjunction to define an integrated action plan.

These and other advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram depicting an integrated action plan forming system in accordance with one embodiment of the present invention.

FIG. 2 is a block diagram depicting an alternative integrated action plan forming system in accordance with another embodiment of the present invention.

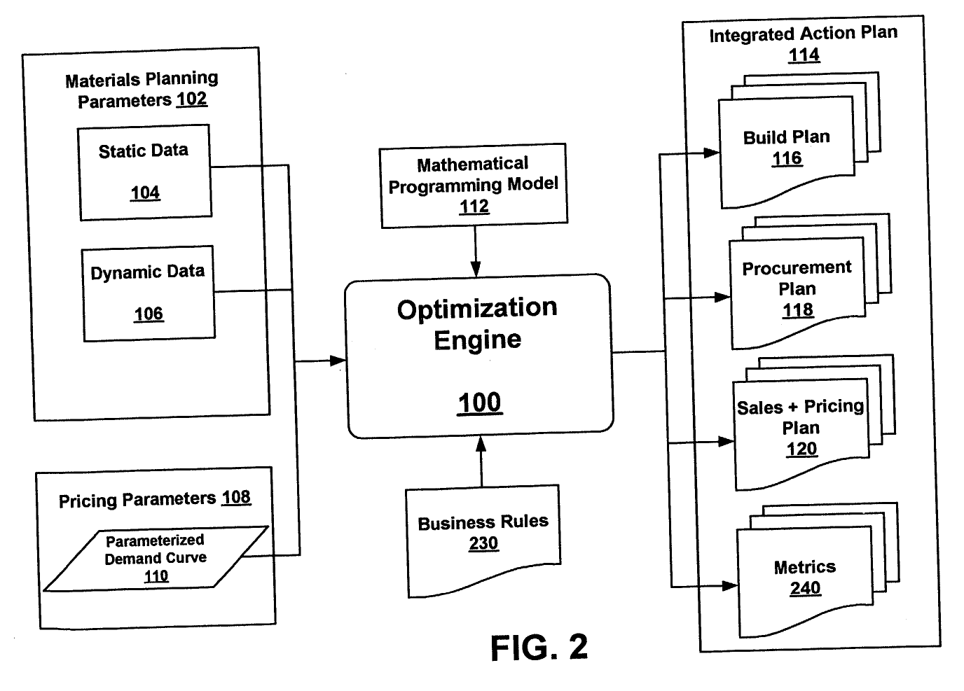

FIG. 3 is a flow chart of steps in a method to define an integrated action plan in accordance with one embodiment of the present invention.

FIG. 4 is a graph of an exemplary process of a method to define an integrated action plan in accordance with one embodiment of the present invention.

The drawings referred to in this description should be understood as not being drawn to scale except if specifically noted.

### BEST MODES FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

In one embodiment, the processes described herein, for example, in flowchart 300, are comprised of computer readable and computer executable instructions which reside in data storage features of a generic computer system. The generic computer system includes, for example, non-volatile and volatile memory, a bus, architecture and a processor. Further, the computer-readable and computer-executable instructions are used to control, or operate in conjunction with, the processor.

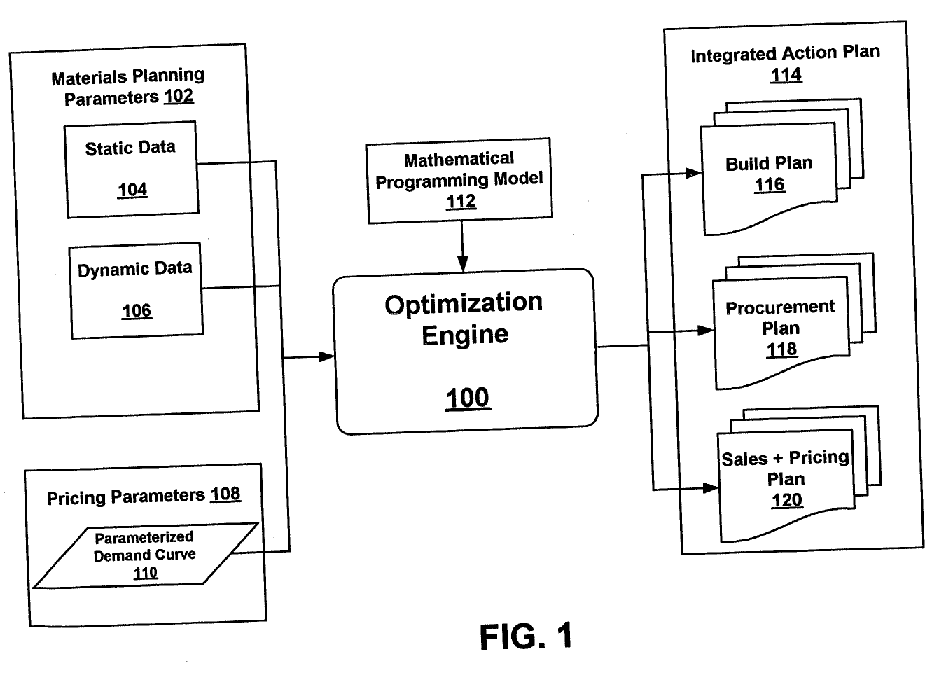

As an overview, the present integrated action plan forming system depicted in FIG. 1, employs an optimization engine 100 which uniquely combines materials planning parameters 102 and pricing parameters 108 to define an integrated action plan 114. Specifically, the integrated action plan forming system considers both manufacturing (i.e. materials planning parameters 102), and marketing (i.e. pricing parameters 108) factors in conjunction to define an integrated action plan 114 (i.e. build plan 116, procurement plan 118, and sales and pricing plan 120). This integrated action plan forming system is unlike the approach taken by the prior art. In the prior art, materials planning parameters 102 and pricing parameters 108 were analyzed independently. Further, the results of the analysis were used as antagonistic evidence in a competitive inter-company environment. However, the integrated action plan forming system described below analyzes materials planning parameters 102 and pricing parameters 108 in conjunction to provide valuable results in a cooperative teamwork-oriented format.

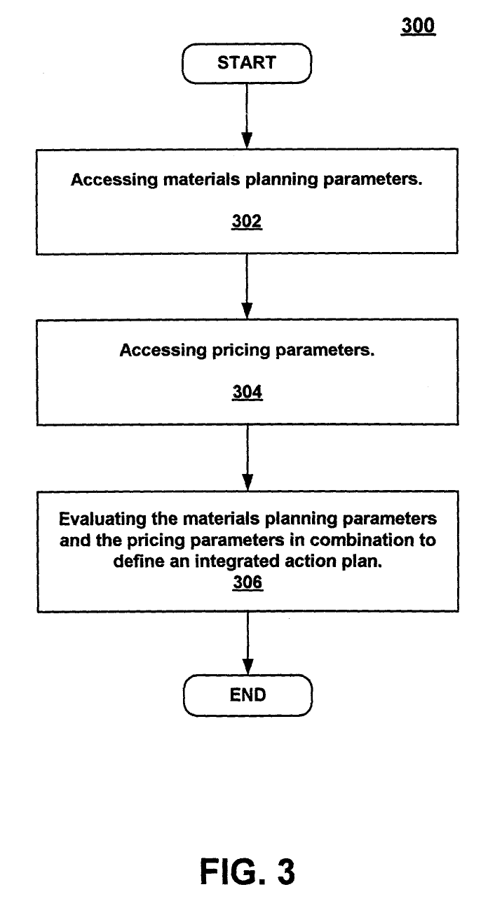

One embodiment of the present integrated action plan forming system is disclosed in FIG. 1. For purposes of clarity, the following discussion will refer to the present integrated action plan forming system of FIG. 1 in conjunction with the flow chart of FIG. 3. Specifically, with reference to step 302 of FIG. 3, the present integrated action plan forming system accesses materials planning parameters 102. Materials planning parameters 102 are comprised of data which provide information regarding the materials that composed the products. In some embodiments that data is static data 104, and in other embodiments it is dynamic data 106.

Static data 104 is comprised of manufacturing and product structure concerns. An example of static data 104 would include aspects of materials planning parameters 102 that change infrequently, such as parts cost, capacity consumption, and a bill-of-materials structure. Specifically, capacity consumption is a measure of resources, such as labor, machine time, etc., which are consumed during product manufacture. A bill-of-materials structure is illustrated in the ensuing example. Initially, a part is an entry in the bill-of-materials structure that has a designated number and an associated cost. A part that is procured from an outside supplier is referred to as a raw material. Therefore, a raw material is a leaf of the bill-of-materials structure. Further, an assembly is a part that may be made out of raw material or other assemblies, which may not normally be sold to an end customer. Assemblies and raw material are then made into products which may be sold to an end customer and will have an associated demand forecast as well as a selling price. Although the illustrated embodiment of the bill-of-materials structure limits the buying and selling of intermediate work products, the present invention is well suited to the allowance of buying and selling of intermediate work products, thus merging the notion of raw materials, assembly and product.

Dynamic data 106 is comprised of manufacturing inventory concerns. An example of dynamic data 106 would include things that change frequently such as on-order or on-hand inventory. Specifically, the purpose of dynamic data 106 is to establish both on-hand and on-order availability of parts, raw materials, and assemblies as required by the bill-of-materials structure.

With reference still to step 302 and to integrated action plan forming system of FIG. 1, materials planning parameters 102 use static data 104 and dynamic data 106 to estimate product production capabilities and to define a manufacturing budget. These estimations become extremely important to a manufacturer during a product discontinuation or single-run period (referred to as an end of life production cycle or EOL). For example, if a specific deadline is established for a product, the analysis of static data 104 and dynamic data 106 evaluated in combination offers a solid framework regarding the amount of product that may be manufactured. Specifically, this evaluation may result in a forecasted production number limited by issues such as, a parts shortage arising from dynamic data 106, or manufacturing budget constraints placed on the EOL emerging from static data 104.

The evaluation of materials planning parameters 102 as described above, are an obvious stopping point for most EOL analysis. Specifically, in many conventional approaches, materials planning parameters 102, such as the afore mentioned, are used exclusively to develop an end of life product cycle. However, other valuable information resides in various marketing issues which may not have the same objective as materials planning parameters 102.

One of the various marketing issues which has a different objective than materials planning parameters 102 is pricing parameters 108. In one embodiment, as shown in FIG. 1, pricing parameters 108 are data that ascertain the selling price of a product. This is accomplished by utilizing pricing information generating techniques to produce a parameterized demand curve 110.

With reference now to step 304 of FIG. 3 and to FIG. 1, the present invention accesses pricing parameters 108. Pricing parameters 108 are comprised of a discret parameterized demand curve 110. Although a discret parameterized demand curve 110 is explicitly mentioned, the present invention is also well suited to a continuous parameterized demand curve 110. Specifically, parameterized demand curve 110 is formed from a pricing information generating technique known as an auction price analyzer. Other methods to generate parameterized demand curve 110 include, a consumer survey, a panel of judges, or a statistical regression based model. Although many forms of pricing information generating techniques are disclosed in this embodiment, there are many more forms of pricing information generating techniques which are familiar to those skilled in the art, and which may be used by the present invention, but which are not disclosed for purposes of brevity.

Parameterized demand curve 110 is used to evaluate sales information with regard to a particular product. This information is then used to determine a distinct marketing goal. For example, a market is analyzed with regard to the demand for a product. In such an analysis, a high demand for the product may result in a high price estimation, while a low demand for the product may result in a low price estimation. Specifically, the analysis results in a sales goal based on the explicit demand for a product. In such an analysis, the resulting sales goals are independent of any production variables.

These pricing parameters 108 accessed at step 304 are another evaluating technique which may be used as a single step method to resolve an EOL issue. The problem with using this method as a single step, is that the assumed demand may not accurately model the actual production capability. This discrepancy is due to the marketing evaluation being independent of any manufacturing reality. Therefore, when pricing parameters 108 are the only parameters considered, they may project marketing objectives which are incongruent with manufacturing abilities.

With reference now to step 306 of FIG. 3 and to FIG. 1, in order to facilitate the combination of materials planning parameters 102 and pricing parameters 108, a new evaluation technique is required. Therefore, the present invention evaluates materials planning parameters 102 and pricing parameters 108 in combination to define an integrated action plan 114. This evaluation is done via optimization engine 100. Specifically, optimization engine 100, unlike prior art approaches, has a goal of either maximization of product gross profit, or optimizing the trade-off between product gross profit maximization and inventory write-off cost minimization. Further, optimization engine 100 attains the desired marketing or manufacturing goals in the institution of integrated action plan 114. The particulars of integrated action plan 114, as generated by the present integrated action plan forming system, will be described in detail below.

At step 306, optimization engine 100 employs mathematical programming model 112 to productively combine both materials planning parameters 102 and pricing parameters 108. Since pricing parameters 108 are in the form of a parameterized demand curve 110, they are easily evaluated by mathematical programming model 112, however, in order to facilitate materials planning parameters 102, a mathematical format of the constraints identified by materials planning parameters 102 must be provided to optimization engine 100. Specifically, product, assembly, and raw material inventory balance equations constituting the bulk of materials planning parameters 102 must be included in the constraint set. In another embodiment, any procurement budget constraints which may be required to set the maximum dollar amount for purchase of raw materials, in order to support the optimal product mix-to-sell ratio, also need to be included as constraints. In a further embodiment, any materials planning parameters 102 which allow specified limits with regard to raw materials, as indicated by the bill-of-materials structure, which may be obtained within the product end-of-life planning horizon, must also be considered as constraints.

Mathematical programming model 112 (employed by optimization engine 100 at step 306), materials planning parameters 102, and pricing parameters 108 illustrate an exemplary version of mathematical programming model 112 as shown in detail below. This example represents one embodiment of the invention and is by no means restricted to it. Mathematical programming model 112 entails input parameters, decision variables, constraints, and an objective function. The decision variables are the course of action to be determined. The constraints represent the relationships among the decision variables with regard to the business problem being addressed. The objective function represents the business objective to optimize. The following notation appears in at least a portion of the exemplary version of mathematical programming model 112 and is included herein to clearly illustrate what the equations are accomplishing.

Indices

i, j: indices for part numbers.

n: number of products to be discontinued

Parameters

PARTS: Set of part numbers in the bill-of-materials of the products to be discontinued.

PRDS: Set of part numbers referring to products. For these products there is a demand forecast and a selling price

ASSY: Set of part numbers that are assemblies.

RAWMAT: Set of part numbers that are raw material.

UNIQ: Set of part numbers that are unique.

BUDGET: Maximum dollar amount to expend on procurement of raw materials.

SALVAGE: Percentage of standard material cost that can be recovered by scrapping parts. If negative, this is the cost of scrapping the material.

NORECOVER=1−SALVAGE. The percentage of standard material cost that is lost scrapping parts.

FORECASTᵢ: Total forecasted demand for product i during planning horizon.

PRICEᵢ: Selling price associated with each unit of product i.

COSTᵢ: Standard material cost of part number i.

INVᵢ: Inventory position of part i. This includes on-hand, in-process, and in-transit inventory.

LIMITᵢ: Maximum number of units of raw material i available within planning horizon.

BOM_{j,i}: Number of parts i required to make assembly j.

PARENT (i) : Set of parts j that require part i as a component.

Π: Penalty factor for production or procurement. This penalty factor is used to avoid procurement or production of parts just to build inventory, with no sales.

GP: Gross Profit generated by Integrated plan.

Variables

sellᵢ: Quantity of product i that is optimal to sell.

makeᵢ: Quantity of product or assembly i that is optimal to build.

buyᵢ: Quantity of raw materials i that is optimal to procure.

writeoffᵢ: Quantity of part i to be written off at the end of planning horizon.

In the present embodiment, five specific constraints of mathematical programming model 112 are utilized. These constraints include balance inventory constraints, budget constraints, demand constraints, supply constraints, and non-negativity constraints.

The balance inventory constraints are used to balance material inventory parameters 102.

$${INV}_{i} + {buy}_{i ∈ RAWMAT} + {make}_{i ∈ PRDS ⋃ ASSY} = {\sum }_{j ∈ PARENT ( i )} {BOM}_{j , i} * {make}_{j} + {writeoff}_{i} + {sell}_{i ∈ PRDS}$$

(The notation variable_{indexεset} denotes that the variable is only part of the constraint if the index is in the specified set.) They further result in an integrated action plan 114 developed within the specified constraints.

The budget constraint assures that total parts purchase cost is less than the specified budget.

$${\sum }_{i ∈ RAWMAT ⋂ UNIQ} {COST}_{i} * {buy}_{i} \leq BUDGET$$

The demand constraints assure that the amount of product which may be built will not surpass the forecasted demand.

sellⱼ≦FORECASTᵢ

The supply constraint limits the buy quantity by the available supply.

buyₗ≦LIMITₗ

The non-negativity constraints assure that each portion of the previously mentioned constraints remains positive in value.

sellᵢ, makeₗ, buyₗ, writeoffₗ≧0

Although five specific constraints are defined, it is obvious that any number of other business rules 230 expressed as constraints may be applied to mathematical programming model 112 of the present invention. In fact, the present invention is well suited to the addition or detraction of business rules 230 as specified by any EOL production requirements.

The present embodiment uses the following objective function for mathematical programming model 112. However the invention is not restricted to this objective since trade-offs between conflicting objectives can be included; for example trade-offs between gross profit maximization and write-off cost minimization.

$$GP = {\sum }_{j ∈ PRDS} {\sum }_{r} {PRICE}_{j}^{r} * {z}_{j}^{r} - {\sum }_{i ∈ RAWMAT} {COST}_{i} - {\sum }_{i ∈ PARTS} {COST}_{i} * {INV}_{i} + SALVAGE * {\sum }_{i ∈ PARTS} {COST}_{i} * {writeoff}_{i} - {\sum }_{i ∈ PRDS ⋃ ASSY} Π * {make}_{i}$$

The above equation is linear in all decision variables. Although the revenue term is quadratic,

$${\sum }_{j ∈ PRDS} {\sum }_{r} {PRICE}_{j}^{r} * {δ}_{j}^{r} * {sell}_{j} ,$$

where

$$\begin{matrix}{δ}_{j}^{r} = \{ \begin{matrix}1 & if product j is sold at price {p}_{j}^{r} \\ 0 & otherwise\end{matrix} \\ and {\sum }_{r} {δ}_{j}^{r} = 1 for each product j .\end{matrix}$$

To simplify the model, the quadratic term is linearized; therefore, a new decision variable is defined

$${z}_{j}^{r} = {δ}_{j}^{r} * {sell}_{j}$$

. To ensure that

$${z}_{j}^{r}$$

behaves as the quadratic term

$${δ}_{j}^{r} * {sell}_{j}$$

the following constraints are applied:

$$\begin{matrix}0 \leq {z}_{j}^{r} \leq {FORECAST}_{j}^{r} * {δ}_{j}^{r} \\ {z}_{j}^{r} \leq {sell}_{j} \\ {sell}_{j} \leq {\sum }_{r} {δ}_{j}^{r} * {FORECAST}_{j}\end{matrix}$$

Therefore, as long as prices are non-negative, the zⱼ variable tends to reach its upper bound sellⱼ, since the gross profit is maximized. The resulting mixed integer model has one binary variable for every product price combination, in practice, this is a manageable number and an optimal solution can be found within seconds. One example of the optimization engine 100 is a branch & bound (cut) solver. This type of solvers is suitable for the mixed integer programming model presented as one embodiment of the present invention. However, constraint programming and meta-heuristics (genetic algorithms, tabu search, simulated annealing) represent alternative solvers that can also be used as optimization engine 100.

A specific mathematical programming model 112 has been shown for purposes of clarity and is understood that the present invention is not limited to this specific model, but in fact applicable over many different mathematical programming models 112, such as, linear programming, mixed integer programming, and non-linear programming, which are familiar to those skilled in the art. Further, the list of mathematical programming models 112 and optimization engines 100 described herein are not intended to be exclusive, but to represent the plurality of possible mathematical programming models 112 and optimization engines 100 available to this invention by one skilled in the art.

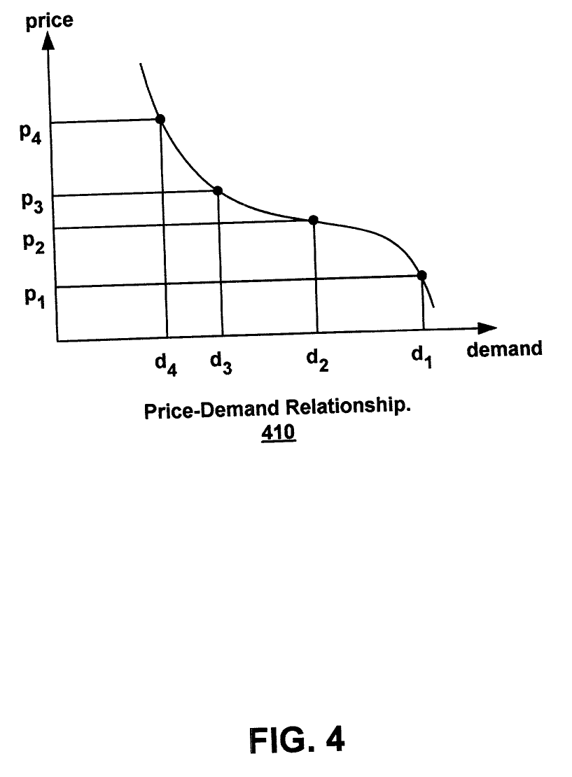

With further reference to FIG. 3 step 306 and now to FIG. 4, in one embodiment, mathematical programming model 112 make a few assumptions in order to specify parameters that may otherwise cause programming errors. For example, mathematical programming model 112 assumes linear pricing for components and products, instantaneous supply, infinite build to order capacity, and infinitely divisible products. In addition, mathematical programming model 112 assumes a uniform scrap

Thus, the present invention provides, in various embodiments, a method to define an optimal integrated action plan for procurement, manufacturing, and marketing. It further provides a method to define an optimal integrated action plan for procurement, manufacturing, and marketing which enables a price per product dependent on the amount of product which can be manufactured. The present invention also provides a method to define an optimal integrated action plan for procurement, manufacturing, and marketing which meets the above needs and which allows the manufacturing decisions to implicitly make the pricing decisions. The present invention further provides a method to define an optimal integrated action plan for procurement, manufacturing, and marketing which meets the above needs and which is based on objective data and facts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for defining an optimal integrated action plan for procurement, manufacturing, and marketing comprising:
a) accessing materials planning parameters;
b) accessing pricing parameters; and
c) evaluating said materials planning parameters and said pricing parameters in conjunction to define said integrated action plan.

2. The method as recited in claim 1, wherein said integrated action plan comprises:
a build plan, a procurement plan, and a sales and pricing plan.

3. The method as recited in claim 2, wherein said integrated action plan is an end of product life integrated action plan.

4. The method as recited in claim 2, wherein said integrated action plan is a short life cycle integrated action plan.

5. The method as recited in claim 1, wherein said materials planning parameters comprise:
bill of material, and inventory.

6. The method as recited in claim 1, wherein said pricing parameters comprise:
a parameterized demand curve formed using a pricing information generating technique.

7. The method as recited in claim 1, wherein said evaluating said materials planning parameters and said pricing parameters is done via an optimization engine employing a mathematical programming model and technique.

8. The method as recited in claim 7, wherein the goal of said optimization engine is maximization of product gross profit.

9. The method as recited in claim 7, wherein the goal of said optimization engine is optimizing the trade-off between product gross profit maximization and inventory write-off cost minimization.

10. The method as recited in claim 7, wherein business rules are applied to said optimization engine.

11. The method as recited in claim 10, wherein said business rules comprise:
objectives, budgets, parts procurement limits, and build capacity.

12. A computer system comprising:
a bus;
a memory unit coupled to said bus; and
a processor coupled to said bus, said processor for executing a method for defining an optimal integrated action plan for procurement, manufacturing, and marketing comprising:
a) accessing materials planning parameters, said materials planning parameters comprising:
bill of material, parts cost, capacity consumption, and inventory;
b) accessing pricing parameters, said pricing parameters comprising:
a parameterized demand curve, said parameterized demand curve formed using a pricing information generating technique, said pricing information generating technique obtained from the family of pricing information generating techniques comprising:
auction price analyzer, consumer survey, panel of judges, and statistical regression based models; and
c) evaluating said materials planning parameters and said pricing parameters in conjunction via an optimization engine, wherein said optimization engine employs a mathematical programming model and technique.

13. The computer system of claim 12, wherein the goal of said optimization engine comprises:
maximizing product gross profit, or optimizing the trade-off between product gross profit maximization and inventory write-off cost minimization.

14. The computer system of claim 13, wherein business rules are applied to said optimization engine.

15. The computer system of claim 14, wherein said business rules comprise:
objectives, budgets, parts procurement limits, and build capacity.

16. The computer system of claim 15, wherein said objectives comprise:
revenue, write-off, and profit.

17. The computer system of claim 12, wherein said integrated action plan further comprises:
a build plan, a procurement plan, and a sales and pricing plan.

18. The computer system of claim 17, wherein said integrated action plan is an end of product life integrated action plan.

19. The computer system of claim 17, wherein said integrated action plan is a short life cycle plan.

20. The computer system of claim 17, wherein said integrated action plan is further comprised of metrics.

21. The computer system of claim 20, wherein said metrics comprise:
revenue, write-off, profit, and shadow prices.

22. The computer system of claim 12, wherein said pricing parameters are obtained from a discrete said parameterized demand curve.

23. The computer system of claim 12, wherein said pricing parameters are obtained from a continuous said parameterized demand curve.

24. The computer system of claim 12, wherein said mathematical programming model and technique is obtained from the family of mathematical programming models and techniques comprising:
mixed integer models, linear models, non-linear models, and techniques such as simplex methods, interior point methods, branch and bound (cut), constraint programming, and meta-heuristics.

25. A computer-usable medium having computer-readable program code embodied therein for causing a computer system to perform a method for defining an optimal integrated action plan for procurement, manufacturing, and marketing comprising:
a) accessing materials planning parameters;
b) accessing pricing parameters; and
c) evaluating said materials planning parameters and said pricing parameters in conjunction to define said integrated action plan.

26. The computer-usable medium of claim 25, wherein said integrated action plan comprises:
a build plan, a procurement plan, and a sales and pricing plan.

27. The computer-usable medium of claim 26, wherein said integrated action plan is an end of product life integrated action plan.

28. The computer-usable medium of claim 26, wherein said integrated action plan is a short life cycle integrated action plan.

29. The computer-usable medium of claim 25, wherein said materials planning parameters comprise:
bill of material, and inventory.

30. The computer-usable medium of claim 25, wherein said pricing parameters comprise:
a parameterized demand curve formed using a pricing information generating technique.

31. The computer-usable medium of claim 25, wherein said evaluating said materials planning parameters and said pricing parameters is done via an optimization engine employing a mathematical programming model and technique.

32. The computer-usable medium of claim 31, wherein the goal of said optimization engine is maximization of product gross profit.

33. The computer-usable medium of claim 31, wherein the goal of said optimization engine is optimizing the trade-off between product gross profit maximization and inventory write-off cost minimization.

34. The computer-usable medium of claim 31, wherein business rules are applied to said optimization engine.

35. The computer-usable medium of claim 34, wherein said business rules comprise:
objectives, budgets, parts procurement limits, and build capacity.
